(19) United States
(12) Patent Application Publication
(10) Pub. No.: US 2026/0284474 A1
(43) Pub. Date: Sep. 24, 2026

(54) METHOD AND SYSTEM FOR FINDING CAUSES OF MISSED SHOTS

(71) Applicant: CREATZ INC., Suwon-si (KR)

(72) Inventors: Jong Tack KIM, Seoul (KR); Ki Ho HONG, Uiwang-si (KR); Hyun Jung LEE, Seoul (KR); Dong Ik LEE, Seoul (KR)

(73) Assignee: CREATZ INC., Suwon-si (KR)

(21) Appl. No.: 19/569,319

(22) Filed: Mar. 17, 2026

(30) Foreign Application Priority Data
Mar. 18, 2025 (KR) 10-2025-0034734

(51) Int. Cl. A63B 24/00; G06V 10/74; G06V 10/764; G06V 40/10; G06V 40/20

(52) U.S. Cl. CPC A63B 24/0003; A63B 24/0021; G06V 10/74; G06V 10/764; G06V 40/10; G06V 40/23; A63B 2024/0034

(57) ABSTRACT

Provided is a method for finding a cause of a second classification. The method includes acquiring at least one of shot physical quantity data and swing image data for an individual shot to perform a swing posture diagnosis of the individual shot using an artificial intelligence model; evaluating the shot physical quantity data for the individual shot as a first classification or a second classification with reference to the shot physical quantity data; and analyzing a cause of the second classification with reference to at least one of data on the swing posture diagnosis and data evaluated as the first classification or the second classification.

### CROSS-REFERENCE TO RELATED APPLICATION

This application claims priority to Korean Patent Application No. 10-2025-0034734 filed on Mar. 18, 2025, the entire contents of which are herein incorporated by reference.

### FIELD OF THE INVENTION

The present invention relates to a method and system for finding causes of missed shots.

### BACKGROUND

In recent years, the domestic and international golf industries have been steadily growing as the number of people playing golf has been increasing with the increase in leisure time, and various techniques for assisting in improving golf skills are being proposed.

Since golf is a sport in which a user (e.g., a golfer) uses a golf club to perform a golf swing to send a golf ball to a target location, analyzing the user's golf swing and accordingly providing appropriate feedback may be helpful in improving the user's golf skills.

One example of conventional golf swing analysis methods is to compare a user's swings with established swing references (e.g., professional swings or standard swings) to detect abnormal swings among the user's swings and provide feedback thereon.

However, the conventional golf swing analysis methods present a problem that the user is provided with an excessive number of swing indicators, making it difficult for the user to select and identify important indicators from the diagnostic results.

Further, the conventional golf swing analysis methods present a problem that swing errors may occur even in good shots (e.g., golf swing habits of each individual may be detected as errors in artificial intelligence model diagnosis), and the same issues detected in good shots may also be detected in missed shots, making it difficult for the user to specify the causes of missed shots.

In this connection, the inventor(s) present a technique for acquiring at least one of shot physical quantity data and swing image data for an individual shot to perform a swing posture diagnosis of the individual shot using an artificial intelligence model, evaluating the shot physical quantity data for the individual shot as a first classification or a second classification with reference to the shot physical quantity data, analyzing a cause of the second classification with reference to at least one of data on the swing posture diagnosis and data evaluated as the first classification or the second classification, and placing a problem occurring only in the second classification at an upper part of an error diagnosis list, thereby assisting a user to easily identify the true cause of the second classification.

### PRIOR ART DOCUMENTS

### PATENT DOCUMENTS

(Patent Document 0001) Korean Laid-Open Patent Publication No. 10-2014-0099199 (Aug. 11, 2014)

### SUMMARY OF THE INVENTION

One object of the present invention is to solve all the above-described problems in the prior art.

Another object of the invention is to acquire at least one of shot physical quantity data and swing image data for an individual shot to perform a swing posture diagnosis of the individual shot using an artificial intelligence model, evaluate the shot physical quantity data for the individual shot as a first classification or a second classification with reference to the shot physical quantity data, and analyze a cause of the second classification with reference to at least one of data on the swing posture diagnosis and data evaluated as the first classification or the second classification.

Another object of the invention is to present a technique for calculating a second classification correlation score for finding a cause of a second classification with reference to at least one of data on a swing posture diagnosis and data evaluated as a first classification or a second classification, and analyzing the cause of the second classification with reference to the second classification correlation score.

Yet another object of the invention is to variably calculate an evaluation criterion of a specific user for a first classification or a second classification with reference to shot physical quantity data for at least one individual shot of the specific user.

The representative configurations of the invention to achieve the above objects are described below.

According to one aspect of the invention, there is provided a method for finding a cause of a second classification, the method comprising the steps of: acquiring at least one of shot physical quantity data and swing image data for an individual shot to perform a swing posture diagnosis of the individual shot using an artificial intelligence model; evaluating the shot physical quantity data for the individual shot as a first classification or a second classification with reference to the shot physical quantity data; and analyzing a cause of the second classification with reference to at least one of data on the swing posture diagnosis and data evaluated as the first classification or the second classification.

According to another aspect of the invention, there is provided a system for finding a cause of a second classification, the system comprising: a posture diagnosis unit configured to acquire at least one of shot physical quantity data and swing image data for an individual shot to perform a swing posture diagnosis of the individual shot using an artificial intelligence model; an evaluation unit configured to evaluate the shot physical quantity data for the individual shot as a first classification or a second classification with reference to the shot physical quantity data; and a cause analysis unit configured to analyze a cause of the second classification with reference to at least one of data on the swing posture diagnosis and data evaluated as the first classification or the second classification.

In addition, there are further provided other methods and systems to implement the invention, as well as non-transitory computer-readable recording media having stored thereon computer programs for executing the methods.

According to the invention, it is possible to acquire at least one of shot physical quantity data and swing image data for an individual shot to perform a swing posture diagnosis of the individual shot using an artificial intelligence model, evaluate the shot physical quantity data for the individual shot as a first classification or a second classification with reference to the shot physical quantity data, and analyze a cause of the second classification with reference to at least one of data on the swing posture diagnosis and data evaluated as the first classification or the second classification.

According to the invention, it is possible to present a technique for calculating a second classification correlation score for finding a cause of a second classification with reference to at least one of data on a swing posture diagnosis and data evaluated as a first classification or a second classification, and analyzing the cause of the second classification.

According to the invention, it is possible to variably calculate an evaluation criterion of a specific user for a first classification or a second classification with reference to shot physical quantity data for at least one individual shot of the specific user.

### BRIEF DESCRIPTION OF THE DRAWINGS

FIG. 1 schematically shows the configuration of an entire system according to one embodiment of the invention.

FIG. 2 specifically shows the internal configuration of a second classification cause analysis system according to one embodiment of the invention.

FIG. 3 illustratively shows a user interface of the second classification cause analysis system according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

### Configuration of the entire system

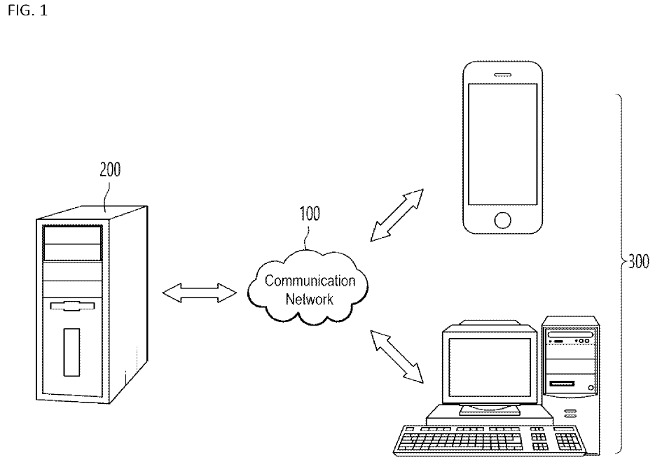

FIG. 1 schematically shows the configuration of the entire system according to one embodiment of the invention.

As shown in FIG. 1, the entire system according to one embodiment of the invention may comprise a communication network 100, a second classification cause analysis system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the second classification cause analysis system 200 according to one embodiment of the invention is a system for finding a cause of a second classification, and may acquire at least one of shot physical quantity data and swing image data for an individual shot to perform a swing posture diagnosis of the individual shot using an artificial intelligence model, evaluate the individual shot as a first classification or a second classification with reference to at least one of the shot physical quantity data and data on the swing posture diagnosis, and analyze a cause of the second classification with reference to data evaluated as the first classification or the second classification.

The configuration and functions of the second classification cause analysis system 200 according to the invention will be discussed in more detail below.

Next, the device 300 according to one embodiment of the invention is digital equipment capable of connecting to and then communicating with the second classification cause analysis system 200, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDA), a web pad, and a mobile phone, may be adopted as the device 300 according to the invention.

In particular, the device 300 may include an application (not shown) for assisting the user to be provided with the functions according to the invention from the second classification cause analysis system 200. The application may be downloaded from the second classification cause analysis system 200 or an external application distribution server (not shown). Meanwhile, the characteristics of the application may be generally similar to those of a posture diagnosis unit 210, an evaluation unit 220, a cause analysis unit 230, a communication unit 240, and a control unit 250 of the second classification cause analysis system 200 to be described below. Here, at least a part of the application may be replaced with a hardware device or a firmware device that may perform a substantially equal or equivalent function, as necessary.

### Configuration of the second classification cause analysis system

Hereinafter, the internal configuration of the second classification cause analysis system 200 crucial for implementing the invention and the functions of the respective components thereof will be discussed.

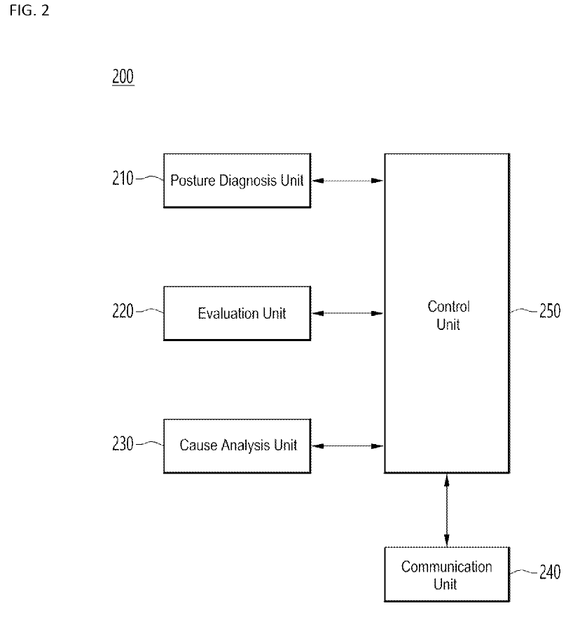

FIG. 2 specifically shows the internal configuration of the second classification cause analysis system 200 according to one embodiment of the invention.

As shown in FIG. 2, the second classification cause analysis system 200 according to one embodiment of the invention may comprise a posture diagnosis unit 210, an evaluation unit 220, a cause analysis unit 230, a communication unit 240, and a control unit 250. According to one embodiment of the invention, at least some of the posture diagnosis unit 210, the evaluation unit 220, the cause analysis unit 230, the communication unit 240, and the control unit 250 may be program modules to communicate with an external system (not shown). The program modules may be included in the second classification cause analysis system 200 in the form of operating systems, application program modules, and other program modules, while they may be physically stored in a variety of commonly known storage devices. Further, the program modules may also be stored in a remote storage device that may communicate with the second classification cause analysis system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the second classification cause analysis system 200 has been described as above, and it will be apparent to those skilled in the art that at least a part of the components or functions of the second classification cause analysis system 200 may be implemented in the device 300 or a server (not shown) or included in an external system (not shown), as necessary.

First, the posture diagnosis unit 210 according to one embodiment of the invention may acquire at least one of shot physical quantity data and swing image data for an individual shot of a user to perform a swing posture diagnosis of the individual shot using an artificial intelligence model.

Specifically, the swing image data for the individual shot according to one embodiment of the invention may be acquired from at least one sensor (e.g., an image sensor such as a camera), and there may be a plurality of swing images for the individual shot. For example, according to one embodiment of the invention, when the user performs a swing for an individual shot, the posture diagnosis unit 210 may acquire an image of the swing for the individual shot photographed by a camera facing the front of the user, and an image of the swing for the individual shot photographed by a camera facing the side of the user. However, the directions of photographing the swing images for the individual shot are not limited to the front and side.

Meanwhile, the swing images for the individual shot according to one embodiment of the invention may be acquired by a sensor other than the image sensor, or may be acquired from a database included in the second classification cause analysis system 200, an external system, or a golf swing database (not shown).

Further, the shot physical quantity data for the individual shot according to one embodiment of the invention may be acquired by a sensor other than the at least one sensor (e.g., a sensor attached to and/or mounted on a golf ball and a golf club) and may include data acquired from the shot and the club, or may be acquired from a database included in the second classification cause analysis system 200, an external system, or a golf swing database (not shown).

However, it is noted that the methods of acquiring the swing images and the shot physical quantity data for the individual shot according to one embodiment of the invention are not necessarily limited to the foregoing, but may be changed without limitation as long as the objects of the invention may be achieved.

Further, the posture diagnosis unit 210 according to one embodiment of the invention may perform a swing posture diagnosis and a motion diagnosis of the individual shot using an artificial intelligence model.

For example, the posture diagnosis unit 210 according to one embodiment of the invention may diagnose and record swing posture diagnosis problems for the individual shot as problem A, problem B, problem C, problem D, and the like (hereinafter referred to as A, B, C, D, and the like), and the cause analysis unit 230 to be described below may analyze a cause of a second classification using the diagnosed problems A, B, C, D, and the like.

Meanwhile, the posture diagnosis unit 210 according to one embodiment of the invention may acquire the data by determining that only individual shots satisfying a certain criterion are valid.

Specifically, the posture diagnosis unit 210 according to one embodiment of the invention may acquire only data of individual shots satisfying a certain criterion by setting a reference value with reference to the mean and standard deviation values of shot physical quantity data for a plurality of individual shots of a specific user, and excluding values that deviate from the reference value (e.g., excluding data where a carry distance is excessively short from the user's individual shot data).

Next, the evaluation unit 220 according to one embodiment of the invention may function to evaluate the shot physical quantity data for the individual shot as a first classification or a second classification.

Specifically, the evaluation unit 220 according to one embodiment of the invention may evaluate the shot physical quantity data for the individual shot of the user as a first classification or a second classification with reference to at least one of the shot physical quantity data for the individual shot of the user and data on the swing posture diagnosis acquired and/or performed by the posture diagnosis unit 210.

Here, the evaluation unit 220 according to one embodiment of the invention may evaluate the user's individual shot as a first classification (e.g., good shot) or a second classification (e.g., missed shot) by applying a reference value common to all users according to PGA/LPGA statistics or criteria commonly used among golfers.

However, it is noted that the method of applying a common reference value according to one embodiment of the invention is not necessarily limited to the foregoing, but may be changed without limitation as long as the objects of the invention may be achieved.

Meanwhile, the evaluation unit 220 according to one embodiment of the invention may variably calculate an evaluation criterion of a specific user for the first classification or the second classification with reference to shot physical quantity data for at least one individual shot of the specific user.

Specifically, the evaluation unit 220 according to one embodiment of the invention may variably calculate an evaluation criterion of a specific user for the first classification or the second classification by applying variable values for the first classification (e.g., good shot) and the second classification (e.g., missed shot) with reference to elements (e.g., club speed, ball speed, carry, carry side, launch angle, and back spin) to which personalized criteria are applied according to the specific user's individual shot data.

That is, the evaluation unit 220 according to one embodiment of the invention may assist the specific user to receive an appropriate diagnosis (e.g., numerical values such as carry, carry side, and club/ball speed) matching his/her own skill level by calculating criteria for the first classification (e.g., good shot) and/or the second classification (e.g., missed shot) that match the user's current skill level.

However, it is noted that the elements to which personalized criteria for the first classification and/or the second classification are applied according to the specific user's individual shot data according to one embodiment of the invention are not necessarily limited to the foregoing, but may be changed without limitation as long as the objects of the invention may be achieved.

Meanwhile, the evaluation unit 220 according to one embodiment of the invention may find personalized data intervals for the first classification (e.g., good shot) and/or the second classification (e.g., missed shot) by collecting the specific user's individual shot data and performing clustering on the collected data.

Specifically, the evaluation unit 220 according to one embodiment of the invention may preprocess (e.g., log smoothing for setting a different level of importance for the same numerical difference per interval) the collected individual shot data of the user, cluster the preprocessed data into two clusters using a k-means clustering algorithm, and find a median value with respect to the closest point between the two clusters.

Here, it is noted that the algorithm used in the clustering according to one embodiment of the invention is not necessarily limited to the foregoing (i.e., k-means algorithm), but may be changed without limitation as long as the objects of the invention may be achieved.

Specifically, the evaluation unit 220 according to one embodiment of the invention may cluster a plurality of pieces of individual shot data of the specific user into two random data values, find a median value among the two clustered random data values, and perform clustering again with respect to the median value.

Here, the evaluation unit 220 according to one embodiment of the invention may find a numerical point that serves as a criterion for the first classification and/or the second classification by performing clustering again with respect to the median value until there is no change in the median value or until a point that fails to satisfy a preset criterion appears.

However, the clustering according to one embodiment of the invention does not simply calculate the average of numerical values. Since determination through consistency significantly affects the clustering, a user who is consistent in individual shot swings may show a high ratio of the first classification (e.g., good shot), while a user with low consistency in individual shot swings may show a low ratio of the first classification even if his/her records are good.

Meanwhile, the evaluation unit 220 according to one embodiment of the invention may function to grant titles (e.g., top 5% level) to consistent users in consideration of the fact that clustering indicators are affected by the consistency of individual shots.

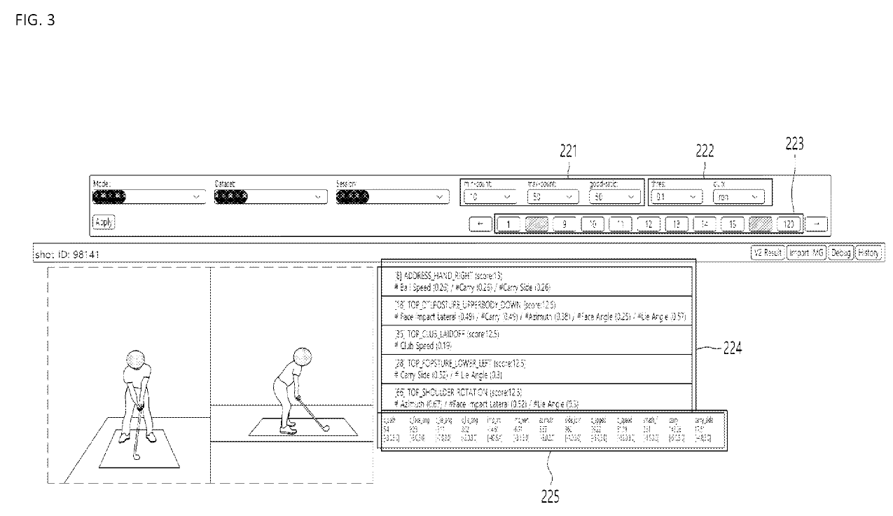

Next, FIG. 3 illustratively shows a user interface of the second classification cause analysis system according to one embodiment of the invention.

Specifically, referring to FIG. 3, the evaluation unit 220 according to one embodiment of the invention may provide a minimum/maximum unit setting function 221, a diagnosis exposure criterion setting function 222, a collected image setting function 223, a diagnosis display setting function 224, and a physical quantity data display setting function 225 on the user interface.

More specifically, the evaluation unit 220 according to one embodiment of the invention may provide the minimum/maximum unit setting function 221 to flexibly perform a swing posture diagnosis using an artificial intelligence model.

For example, the minimum unit setting function according to one embodiment of the invention may implement an algorithm for deriving results through a correlation between accumulated swing posture diagnosis results and measured shot physical quantity data, and thus the minimum shot setting may be two or more shots and accuracy may increase as the minimum unit setting is higher.

Further, the maximum unit setting function according to one embodiment of the invention may limit the number of individual shots to a certain quantity in the latest order, because including shot physical quantity data for past swings that differ significantly from the current skill level may lower the accuracy of measurement diagnosis.

Meanwhile, the evaluation unit 220 according to one embodiment of the invention may allow exposure criteria to be set when a correlation between the shot physical quantity data and posture diagnosis problems of the individual shot is exposed through the diagnosis exposure criterion setting function 222.

Specifically, the evaluation unit 220 according to one embodiment of the invention may allow only data with a high correlation between the shot physical quantity data and the swing posture diagnosis data to be exposed to the user by strictly setting the criteria through the diagnosis exposure criterion setting function 222.

In contrast, the evaluation unit 220 according to one embodiment of the invention may allow data with a low correlation between the shot physical quantity data and the swing posture diagnosis data to be exposed to the user by flexibly setting the criteria through the diagnosis exposure criterion setting function 222.

Meanwhile, the evaluation unit 220 according to one embodiment of the invention may provide data on the number of individual shots stored in a session through the interface for the collected image setting function 223.

Specifically, the evaluation unit 220 according to one embodiment of the invention may provide the number of pieces of data stored in a session on the interface for the collected image setting function 223.

Further, the evaluation unit 220 according to one embodiment of the invention may provide the posture diagnosis results of the artificial intelligence model for the individual shot swing images, the shot physical quantity data matching the posture diagnosis problems of the individual shot, and swing scores of the individual shots through the diagnosis display setting function 224.

For example, the evaluation unit 220 according to one embodiment of the invention may assign an importance score in a range of 1 to 3 points for each of 8 poses of an individual shot swing (e.g., 3 points for an address, 2 points for a back swing, and 2.5 points for a down swing). In the case of a diagnosis where a shot physical quantity data correlation is assigned, +10 points may be additionally assigned so that diagnoses that may be provided together with the shot physical quantity data are exposed at an upper part, and problems regarding important postures among the diagnoses exposed at the upper part may be exposed more distinctly (e.g., by displaying their colors distinctly or listing them at the top).

Meanwhile, the evaluation unit 220 according to one embodiment of the invention may allow criteria for the first classification (e.g., good shot) and the second classification (e.g., missed shot) to be assigned to each piece of shot physical quantity data (e.g., angle, speed, and spin) measured through a sensor.

Here, the evaluation unit 220 according to one embodiment of the invention may provide data on the second classification by listing it at the upper part of an error diagnosis list on the user interface or displaying it with a distinct color through the shot physical quantity data display setting function 225.

However, it is noted that the method by which the evaluation unit 220 according to one embodiment of the invention provides data on the second classification by displaying it distinctly is not necessarily limited to the foregoing, but may be changed without limitation as long as the objects of the invention may be achieved.

Further, the evaluation unit 220 according to one embodiment of the invention may evaluate an individual shot as the first classification (e.g., good shot) or the second classification (e.g., missed shot) with further reference to a ball flight corresponding to the individual shot.

Specifically, the evaluation unit 220 according to one embodiment of the invention may evaluate the user's individual shot as the first classification or the second classification with further reference to the ball flight corresponding to the individual shot, in addition to the shot physical quantity data and the swing posture diagnosis data for the individual shot acquired by the posture diagnosis unit 210, or may evaluate the individual shot as the first classification or the second classification with reference only to the ball flight matching the individual shot.

Meanwhile, the evaluation unit 220 according to one embodiment of the invention may evaluate the individual shot as the first classification (e.g., good shot) or the second classification (e.g., missed shot) by analyzing at least one piece of shot physical quantity data for the individual shot.

For example, the evaluation unit 220 according to one embodiment of the invention may evaluate each piece of shot physical quantity data for the individual shot (e.g., 10-degree push or 1000 rpm draw spin) as the second classification.

Specifically, the evaluation unit 220 according to one embodiment of the invention may collect and analyze all pieces of physical quantity data (e.g., angle, speed, and spin) for the individual shot acquired by the swing posture unit 210 according to one embodiment of the invention, and may evaluate the individual shot as the first classification or the second classification with reference to each piece of the analyzed physical quantity data for the individual shot.

Next, the cause analysis unit 230 according to one embodiment of the invention may function to analyze a cause of the second classification with reference to at least one of the swing posture diagnosis data for the individual shot acquired by the posture diagnosis unit 210 according to one embodiment of the invention and the data on the first classification (e.g., good shot) or the second classification (e.g., missed shot) evaluated by the evaluation unit 220 according to one embodiment of the invention.

Specifically, according to one embodiment of the invention, the cause analysis unit 230 may calculate a second classification correlation score for finding the cause of the second classification and analyze the cause of the second classification with reference to at least one of the swing posture diagnosis data and the data evaluated as the first classification or the second classification by the evaluation unit 220.

More specifically, the cause analysis unit 230 according to one embodiment of the invention may extract at least one piece of first intersection data as the swing posture diagnosis data commonly included only in the data evaluated as the second classification, and may analyze the cause of the second classification by calculating a second classification correlation score for the at least one piece of the extracted first intersection data to exceed a first specific score (i.e., a preset reference score for the second classification).

For example, with respect to swing posture diagnosis problems A, B and C of a first individual shot evaluated as the first classification (e.g., good shot), swing posture diagnosis problems A, B, C and D of a second individual shot evaluated as the second classification (e.g., missed shot), and swing posture diagnosis problems B, D, E and F of a third individual shot evaluated as the second classification (e.g., missed shot), the cause analysis unit 230 according to one embodiment of the invention may extract first intersection data D commonly included only in the swing posture diagnosis problems of the second and third individual shots evaluated as the second classification.

Further, according to one embodiment of the invention, by calculating a second classification correlation score for the at least one piece of the extracted first intersection data D to exceed a first specific score (e.g., 80 points), the user may be informed that problem D is the cause of the second classification (e.g., missed shot).

Furthermore, the cause analysis unit 230 according to one embodiment of the invention may provide data on a specific individual shot by displaying it distinctly in response to a second classification correlation score for the specific individual shot exceeding a third specific score (i.e., a preset reference score for the second classification).

For example, the cause analysis unit 230 according to one embodiment of the invention may provide the cause of the second classification such that the user may understand the cause intuitively and easily, e.g., by listing the correlation data D that exceeds the third specific score at the upper part of the error diagnosis list on the user interface or by displaying it in a distinct color.

However, it is noted that the method by which the cause analysis unit 230 provides the correlation data D exceeding the third specific score by displaying it distinctly is not necessarily limited to the foregoing, but may be changed without limitation as long as the objects of the invention may be achieved.

Meanwhile, the cause analysis unit 230 according to one embodiment of the invention may extract at least one piece of second intersection data as the swing posture diagnosis data commonly included in the data evaluated as the first classification (e.g., good shot) and the data evaluated as the second classification (e.g., missed shot), and may analyze the cause of the second classification by calculating a second classification correlation score for the at least one piece of the extracted second intersection data to be below a second specific score (i.e., a preset reference score for the second classification).

For example, with respect to swing posture diagnosis problems A, B and C of a first individual shot evaluated as the first classification (e.g., good shot), swing posture diagnosis problems A, B, C and D of a second individual shot evaluated as the second classification (e.g., missed shot), and swing posture diagnosis problems B, D, E and F of a third individual shot evaluated as the second classification (e.g., missed shot), the cause analysis unit 230 according to one embodiment of the invention may extract second intersection data A, B and C commonly included in the data evaluated as the first classification and the data evaluated as the second classification.

Further, according to one embodiment of the invention, by calculating a second classification correlation score for the at least one piece of the extracted second intersection data A, B and C to be below a second specific score (e.g., 80 points), it may be analyzed that A, B, and C are highly unlikely to be included in the cause of the second classification.

Here, the first specific score and the second specific score may be the same or different.

Meanwhile, by comparing data acquired from the swing posture diagnosis of a first individual shot corresponding to a first period and data acquired from the swing posture diagnosis of a second individual shot corresponding to a second period, the cause analysis unit 230 according to one embodiment of the invention may provide feedback on the swing posture of the second individual shot.

Here, according to one embodiment of the invention, the first period may precede the second period. That is, the cause analysis unit 230 according to one embodiment of the invention may provide feedback on the swing posture of a specific user's current individual shot by comparing the swing posture diagnosis of the user's past individual shots and the swing posture diagnosis of the current individual shot.

Further, the cause analysis unit 230 according to one embodiment of the invention may send a feedback message (e.g., "Your shot data is improving as the flying elbow problem is corrected!") when errors in the associated individual shot data are resolved or the frequency of errors increases in response to posture errors occurring as the user continues practicing individual shots.

Meanwhile, the cause analysis unit 230 according to one embodiment of the invention may provide statistical data, daily trend data, and the like according to the frequency of occurrence of the first classification (e.g., good shot) and the second classification (e.g., missed shot), and may also provide feedback on lessons/guidance/training methods according to the results of the swing posture diagnosis of individual shots.

For example, the cause analysis unit 230 according to one embodiment of the invention may provide the user with functions such as providing related sites for golf lessons, connecting contents, and recommending professional instructors with reference to the results of the swing posture diagnosis of the user's individual shots.

However, it is noted that the method by which the cause analysis unit 230 provides feedback on lessons/guidance/training methods with reference to the results of the swing posture diagnosis of the user's individual shots is not necessarily limited to the foregoing, but may be changed without limitation as long as the objects of the invention may be achieved.

Meanwhile, the cause analysis unit 230 according to one embodiment of the invention may subdivide the posture importance of each part of a fourth posture of an individual shot swing to assign at least one partial posture score, and provide the fourth posture by displaying it distinctly in response to the sum of the at least one assigned partial posture score exceeding a fourth specific score.

For example, the cause analysis unit 230 according to one embodiment of the invention may provide information on the fourth posture (e.g., postures A, B, C and E) such that the user may understand the information intuitively and easily by exposing it at the upper part of the error diagnosis list on the user interface or displaying it in a different color, in response to the sum of at least one partial posture score (e.g., postures A, B, C and E) exceeding a fourth specific score (e.g., 80 points).

However, it is noted that the method by which the cause analysis unit 230 provides the fourth posture by displaying it distinctly is not necessarily limited to the foregoing, but may be changed without limitation as long as the objects of the invention may be achieved.

Meanwhile, the cause analysis unit 230 according to one embodiment of the invention may provide each error occurring in the second classification (e.g., missed shot) of the user in a statistical format (e.g., percents) as the number of error diagnoses (e.g., deviating left/right from the target, direction miss, and insufficient distance) increases as the user continues practicing.

Further, the cause analysis unit 230 according to one embodiment of the invention may function to prevent the user's confusion caused by the user's past error problems and/or resolved problems by initializing the statistics calculation logic every certain number of strokes (e.g., 30 strokes).

Meanwhile, the cause analysis unit 230 according to one embodiment of the invention may classify and provide problems estimated to be the cause of a missed shot in response to the user performing a search regarding the missed shot through tags.

For example, when the user searches for "hook" in the practice records, the cause analysis unit 230 according to one embodiment of the invention may classify and provide the user with problems detected only in hooks.

Meanwhile, the cause analysis unit 230 according to one embodiment of the invention may cause a server to provide a specific user with data on the specific user compared with data on other users by transmitting the data on the specific user to the server.

For example, by transmitting data on user A to the server, the cause analysis unit 230 according to one embodiment of the invention may cause the server to compare the data on user A with data on other users transmitted to the server, i.e., data on user B, data on user C, and data on user D.

Further, the cause analysis unit 230 according to one embodiment of the invention may cause the server to provide user A with data on problems commonly experienced by other users.

For example, regarding causes a, b, and c that trigger user A's hook problems, the cause analysis unit 230 according to one embodiment of the invention may cause the server according to one embodiment of the invention to provide statistical data on problems that other users also commonly experience (e.g., a (70%), b (40%), and c (60%)).

In addition, the cause analysis unit 230 according to one embodiment of the invention may cause the server according to one embodiment of the invention to provide a specific user with data on the specific user's body and/or posture characteristics.

Specifically, the cause analysis unit 230 according to one embodiment of the invention may cause the server according to one embodiment of the invention to compare and analyze data on user A, data on user B, data on user C, and data on user D, and may cause the server to provide user A with data on the analyzed body and/or posture characteristics of user A.

Further, the cause analysis unit 230 according to one embodiment of the invention may cause the server according to one embodiment of the invention to provide a specific user with data on a segment to which the specific user belongs.

Specifically, the cause analysis unit 230 according to one embodiment of the invention may cause the server according to one embodiment of the invention to compare subdivided data on user A (e.g., gender, age, physical characteristics, and skill level segments) with subdivided data on other users collected in the server.

Furthermore, the cause analysis unit 230 according to one embodiment of the invention may cause the server according to one embodiment of the invention to provide user A with respective information on which segment user A belongs to in the subdivided data (e.g., gender, age, physical characteristics, and skill level segments).

However, it is noted that the classification elements (e.g., gender, age, physical characteristics, and skill level segments) regarding the subdivided data according to one embodiment of the invention are not limited to the foregoing, but may be changed without limitation as long as the objects of the invention may be achieved.

Meanwhile, the cause analysis unit 230 according to one embodiment of the invention may provide the user with a consistent criterion for a second classification correlation score by setting an initial dataset through trial hits. That is, without the user needing to satisfy a minimum unit setting (e.g., 2 shots), a correlation between the shot physical quantity data of the current individual shot swing and the swing posture diagnosis data may be immediately identified by comparing data of the initial dataset with data on the current individual shot swing for every first individual shot swing.

Specifically, the cause analysis unit 230 according to one embodiment of the invention may cause the user to set a reference number of hits (e.g., 10 times), and may set the initial dataset on the basis of data acquired during the set reference number of hits.

For example, the cause analysis unit 230 according to one embodiment of the invention may cause a specific user to perform trial hits for a reference number of hits (e.g., 3 times), thereby acquiring data on swing posture diagnosis problems A, B and C of a first individual shot evaluated as the first classification (e.g., good shot), swing posture diagnosis problems A, B, C and D of a second individual shot evaluated as the second classification (e.g., missed shot), and swing posture diagnosis problems B, D, E and F of a third individual shot evaluated as the second classification (e.g., missed shot), and may set the initial dataset on the basis of the data of the first, second, and third individual shots.

Here, since swing posture D according to one embodiment of the invention is a posture that occurs only in the swing posture diagnosis regarding the second classification (e.g., missed shot), the second classification correlation score related to the second classification may be considered high. Since swing postures A, B and C according to one embodiment of the invention are postures that occur regardless of the first or second classification, the second classification correlation score related to the second classification may be considered low.

With the initial dataset being set as above, in response to a specific user performing a current individual shot swing, the cause analysis unit 230 according to one embodiment of the invention may calculate the second classification correlation score to be higher than a specific score (i.e., a preset reference score for the second classification) if D is included in the swing posture diagnosis problems of the current individual shot, and may calculate the second classification correlation score to be lower than the specific score if at least one of A, B and C is included in the swing posture diagnosis problems of the current individual shot.

Further, the cause analysis unit 230 according to one embodiment of the invention may function to exclude individual shot swing data resulting from errors and/or mistakes among the user's individual shot swing data.

Specifically, the cause analysis unit 230 according to one embodiment of the invention may use an artificial intelligence model to determine shots judged as mistakes, inconsistent shots, and the like among individual shot swings and automatically exclude them from the data or propose the user to exclude them by displaying an exclusion recommendation alarm.

Meanwhile, the cause analysis unit 230 according to one embodiment of the invention may automatically create a new session.

For example, the cause analysis unit 230 according to one embodiment of the invention may function to automatically create a new session once a set number of hits (e.g., a maximum unit setting of 50 hits) has passed.

Meanwhile, the cause analysis unit 230 according to one embodiment of the invention may automatically determine a type of club so that sessions are automatically created by club type even if the user practices swings with mixed clubs, and may allow the user to compare the respective sessions.

Further, the cause analysis unit 230 according to one embodiment of the invention may classify individual shots included in one session (e.g., 50 shots) by club type to generate individual shot diagnosis criteria for each club.

Next, the communication unit 240 according to one embodiment of the invention may function to enable data transmission/reception from/to the posture diagnosis unit 210, the evaluation unit 220, and the cause analysis unit 230.

Lastly, the control unit 250 according to one embodiment of the invention may function to control data flow among the posture diagnosis unit 210, the evaluation unit 220, the cause analysis unit 230, and the communication unit 240. That is, the control unit 250 according to one embodiment of the invention may control data flow into/out of the second classification cause analysis system 200 or data flow among the respective components of the second classification cause analysis system 200, such that the posture diagnosis unit 210, the evaluation unit 220, the cause analysis unit 230, and the communication unit 240 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks, and magnetic tapes; optical media such as compact disk-read only memory (CD-ROM) and digital versatile disks (DVDs); magneto-optical media such as floptical disks; and hardware devices such as read-only memory (ROM), random access memory (RAM), and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### DESCRIPTION OF THE REFERENCE NUMERALS

100: communication network

200: second classification cause analysis system

210: posture diagnosis unit

220: evaluation unit

221: minimum/maximum unit setting

222: diagnosis exposure criterion setting

223: collected image setting

224: diagnosis display setting

225: physical quantity data display setting

230: cause analysis unit

240: communication unit

250: control unit

300: device

1. A method for finding causes of missed shots, the method comprising the steps of:
acquiring at least one of shot physical quantity data and swing image data for an individual shot to perform a swing posture diagnosis of the individual shot using an artificial intelligence model;
evaluating the shot physical quantity data for the individual shot as a first classification or a second classification with reference to the shot physical quantity data; and
analyzing a cause of the second classification with reference to at least one of data on the swing posture diagnosis and data evaluated as the first classification or the second classification.

2. The method of claim 1, wherein in the analyzing step, a second classification correlation score for finding the cause of the second classification is calculated with reference to at least one of the data on the swing posture diagnosis and the data evaluated as the first classification or the second classification, and the cause of the second classification is analyzed with reference to the calculated second classification correlation score.

3. The method of claim 2, wherein in the analyzing step, at least one piece of first intersection data is extracted as the data on the swing posture diagnosis commonly included only in the data evaluated as the second classification.

4. The method of claim 3, wherein in the analyzing step, the cause of the second classification is analyzed by calculating a second classification correlation score for the at least one piece of the extracted first intersection data to exceed a first specific score.

5. The method of claim 2, wherein in the analyzing step, at least one piece of second intersection data is extracted as the data on the swing posture diagnosis commonly included in the data evaluated as the first classification and the data evaluated as the second classification.

6. The method of claim 5, wherein in the analyzing step, the cause of the second classification is analyzed by calculating a second classification correlation score for the at least one piece of the extracted second intersection data to be below a second specific score.

7. The method of claim 2, wherein in the analyzing step, data on a specific individual shot is provided by displaying the data on the specific individual shot distinctly in response to a second classification correlation score for the specific individual shot exceeding a third specific score.

8. The method of claim 1, wherein in the analyzing step, data acquired from the swing posture diagnosis of a first individual shot corresponding to a first period is compared with data acquired from the swing posture diagnosis of a second individual shot corresponding to a second period to provide feedback on a swing posture of the second individual shot, and
wherein the first period precedes the second period.

9. The method of claim 1, wherein in the evaluating step, the individual shot is evaluated as the first classification or the second classification with further reference to a ball flight corresponding to the individual shot.

10. The method of claim 1, wherein in the evaluating step, an evaluation criterion of a specific user for the first classification or the second classification is variably calculated with reference to shot physical quantity data for at least one individual shot of the specific user.

11. The method of claim 1, wherein in the analyzing step, posture importance of each part of a fourth posture of the individual shot swing is subdivided to assign at least one partial posture score.

12. The method of claim 11, wherein in the analyzing step, the fourth posture is provided by displaying the fourth posture distinctly in response to a sum of the at least one assigned partial posture score exceeding a fourth specific score.

13. The method of claim 1, wherein in the evaluating step, the individual shot is evaluated as the first classification or the second classification by analyzing at least one piece of shot physical quantity data for the individual shot.

14. A non-transitory computer-readable recording medium having stored thereon a computer program for executing the method of claim 1.

15. A system for finding causes of missed shots, the system comprising:
a posture diagnosis unit configured to acquire at least one of shot physical quantity data and swing image data for an individual shot to perform a swing posture diagnosis of the individual shot using an artificial intelligence model;
an evaluation unit configured to evaluate the shot physical quantity data for the individual shot as a first classification or a second classification with reference to the shot physical quantity data; and
a cause analysis unit configured to analyze a cause of the second classification with reference to at least one of data on the swing posture diagnosis and data evaluated as the first classification or the second classification.

16. The system of claim 15, wherein the cause analysis unit is configured to calculate a second classification correlation score for finding the cause of the second classification with reference to at least one of the data on the swing posture diagnosis and the data evaluated as the first classification or the second classification, and analyze the cause of the second classification with reference to the calculated second classification correlation score.

17. The system of claim 16, wherein the cause analysis unit is configured to extract at least one piece of first intersection data as the data on the swing posture diagnosis commonly included only in the data evaluated as the second classification.

18. The system of claim 16, wherein the cause analysis unit is configured to extract at least one piece of second intersection data as the data on the swing posture diagnosis commonly included in the data evaluated as the first classification and the data evaluated as the second classification.

19. The system of claim 15, wherein the cause analysis unit is configured to compare data acquired from the swing posture diagnosis of a first individual shot corresponding to a first period with data acquired from the swing posture diagnosis of a second individual shot corresponding to a second period to provide feedback on a swing posture of the second individual shot, and
wherein the first period precedes the second period.

20. The system of claim 15, wherein the evaluation unit is configured to variably calculate an evaluation criterion of a specific user for the first classification or the second classification with reference to shot physical quantity data for at least one individual shot of the specific user.
